(19) United States
(12) Patent Application Publication
(10) Pub. No.: US 2026/0179492 A1
(43) Pub. Date: Jun. 25, 2026

(54) METHOD, APPARATUS, AND SYSTEM OF PROVIDING BEHAVIORAL DRIVEN LANE TRANSITIONS FROM CROWD SOURCED SENSOR DATA

(71) Applicant: HERE Global B.V., Eindhoven (NL)

(72) Inventor: James D. LYNCH, Waterloo, IA (US)

(21) Appl. No.: 18/999,837

(22) Filed: Dec. 23, 2024

(51) Int. Cl. G08G 1/16; B60W 60/00; G08G 1/065

(52) U.S. Cl. CPC G08G 1/167; B60W 60/001; G08G 1/065

(57) ABSTRACT

An approach is provided for determining lane transitions from crowd sourced data. The approach, for instance, involves processing vehicle drive data to determine aggregated vehicle drive geometries. The approach also involves processing vehicle drive data to determine aggregated vehicle drive geometries that reduce the vehicle drive data to one path per lane, one path per maneuver, or a combination thereof. The approach further involves associating and clustering the aggregated vehicle drive geometries into vehicle drive path segments. The approach further involves, for each vehicle drive path segments, determining counts of a number of the one or more vehicles that cross a lane marking, that depart or enter the one or more drive path segments, that have an active turn signal, or a combination thereof. The approach further involves computing one or more lane transition types and/or scores for the vehicle drive path segments based on the counts, and providing the lane transition types and/or scores as an output.

### BACKGROUND

As vehicles gain more autonomous capabilities (e.g., highly assisted driving, fully or partially autonomous driving, etc.), service providers face significant technical challenges with respect to implementing these capabilities in a more “humanized” manner. For example, humanized driving in the context of autonomous or highly assisted vehicles refers to the implementation of driving capabilities that mimic human behavior and decision-making. The goal is to make autonomous driving feel more intuitive and comfortable for human passengers by incorporating real-world driving patterns and preferences into the vehicle's operating system. One of these driving patterns and preferences relate to lane transitions that a vehicle should make in a road network.

### Some Example Embodiments

Therefore, there is a need for an approach for determining lane transitions based on the actual driving behavior of many individuals (e.g., crowd sourced vehicle drive data), rather than relying solely on map features (e.g., intersection markings, lane direction markings, etc.).

According to one embodiment, a method comprises processing vehicle drive data to determine a plurality of aggregated vehicle drive geometries. The vehicle drive data is determined using one or more sensors of one or more vehicles, and the plurality of aggregated vehicle drive geometries reduce the vehicle drive data to one path per lane, one path per maneuver, or a combination thereof. The method also comprises associating and clustering the plurality of aggregated vehicle drive geometries into a plurality of vehicle drive path segments. The method further comprises, for one or more vehicle drive path segments of the plurality of vehicle drive path segments, determining one or more counts of a number of the one or more vehicles that cross a lane marking, that depart or enter the one or more drive path segments, that have an active turn signal, or a combination thereof. The method further comprises computing a lane transition type, a lane transition score, or a combination thereof for the one or more vehicle drive path segments based on the one or more counts. The method further comprises providing the lane transition type, the lane transition score, or a combination thereof as an output.

According to another embodiment, an apparatus comprises at least one processor, and at least one memory including computer program code for one or more computer programs, the at least one memory and the computer program code configured to, with the at least one processor, cause, at least in part, the apparatus to process vehicle drive data to determine a plurality of aggregated vehicle drive geometries. The vehicle drive data is determined using one or more sensors of one or more vehicles, and the plurality of aggregated vehicle drive geometries reduce the vehicle drive data to one path per lane, one path per maneuver, or a combination thereof. The apparatus is also caused to associate and cluster the plurality of aggregated vehicle drive geometries into a plurality of vehicle drive path segments. The apparatus is further caused, for one or more vehicle drive path segments of the plurality of vehicle drive path segments, to determine one or more counts of a number of the one or more vehicles that cross a lane marking, that depart or enter the one or more drive path segments, that have an active turn signal, or a combination thereof. The apparatus is further caused to compute a lane transition type, a lane transition score, or a combination thereof for the one or more vehicle drive path segments based on the one or more counts. The apparatus is further caused to provide the lane transition type, the lane transition score, or a combination thereof as an output.

According to another embodiment, a non-transitory computer-readable storage medium carries one or more sequences of one or more instructions which, when executed by one or more processors, cause, at least in part, an apparatus to process vehicle drive data to determine a plurality of aggregated vehicle drive geometries. The vehicle drive data is determined using one or more sensors of one or more vehicles, and the plurality of aggregated vehicle drive geometries reduce the vehicle drive data to one path per lane, one path per maneuver, or a combination thereof. The apparatus is also caused to associate and cluster the plurality of aggregated vehicle drive geometries into a plurality of vehicle drive path segments. The apparatus is further caused, for one or more vehicle drive path segments of the plurality of vehicle drive path segments, to determine one or more counts of a number of the one or more vehicles that cross a lane marking, that depart or enter the one or more drive path segments, that have an active turn signal, or a combination thereof. The apparatus is further caused to compute a lane transition type, a lane transition score, or a combination thereof for the one or more vehicle drive path segments based on the one or more counts. The apparatus is further caused to provide the lane transition type, the lane transition score, or a combination thereof as an output.

According to another embodiment, an apparatus comprises means for processing vehicle drive data to determine a plurality of aggregated vehicle drive geometries. The vehicle drive data is determined using one or more sensors of one or more vehicles, and the plurality of aggregated vehicle drive geometries reduce the vehicle drive data to one path per lane, one path per maneuver, or a combination thereof. The apparatus also comprises means for associating and clustering the plurality of aggregated vehicle drive geometries into a plurality of vehicle drive path segments. The apparatus further comprises, for one or more vehicle drive path segments of the plurality of vehicle drive path segments, means for determining one or more counts of a number of the one or more vehicles that cross a lane marking, that depart or enter the one or more drive path segments, that have an active turn signal, or a combination thereof. The apparatus further comprises means for computing a lane transition type, a lane transition score, or a combination thereof for the one or more vehicle drive path segments based on the one or more counts. The apparatus further comprises means for providing the lane transition type, the lane transition score, or a combination thereof as an output.

In addition, for various example embodiments described herein, the following is applicable: a computer program product may be provided. For example, a computer program product comprising instructions which, when the program is executed by a computer, cause the computer to perform any one or any combination of methods (or processes) disclosed.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing behavioral driven lane transitions from crowd sourced sensor data, according to one example embodiment;

FIG. 2 is a diagram of components of a mapping platform capable of providing behavioral driven lane transitions from crowd sourced sensor data, according to one example embodiment;

FIG. 3 is a flowchart of a process for providing behavioral driven lane transitions from crowd sourced sensor data, according to one example embodiment;

FIGS. 4A and 4B are diagrams illustrating an example of analyzing drive paths versus lane markings, according to one example embodiment;

FIGS. 5A-5D are diagrams illustrating an example of aggregating and aligning individual vehicle drive paths for determining aggregated behavioral lane transitions, according to one example embodiment;

FIG. 6 is a diagram illustrating an example of aggregation of lane change rates, according to one example embodiment;

FIG. 7 is a diagram of source drives captured for each map tile, according to one example embodiment;

FIG. 8 is a flowchart of a process for aggregation alignment of source drives, according to one example embodiment;

FIGS. 9A-9D are diagrams illustrating an example of aggregating and aligning source drives based on feature detections, according to one example embodiment;

FIG. 10 is a diagram illustrating examples of aggregated behavioral lane transitions, according to one example embodiment;

FIG. 11 is a diagram of a geographic database, according to one embodiment;

FIG. 12 is a diagram of hardware that can be used to implement an embodiment of the invention;

FIG. 13 is a diagram of a chip set that can be used to implement an embodiment of the invention; and

FIG. 14 is a diagram of a mobile terminal that can be used to implement an embodiment of the invention.

### DESCRIPTION OF SOME EMBODIMENTS

Examples of a method, apparatus, and computer program for providing behavioral driven lane transitions from crowd sourced sensor data, according to various example embodiments. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

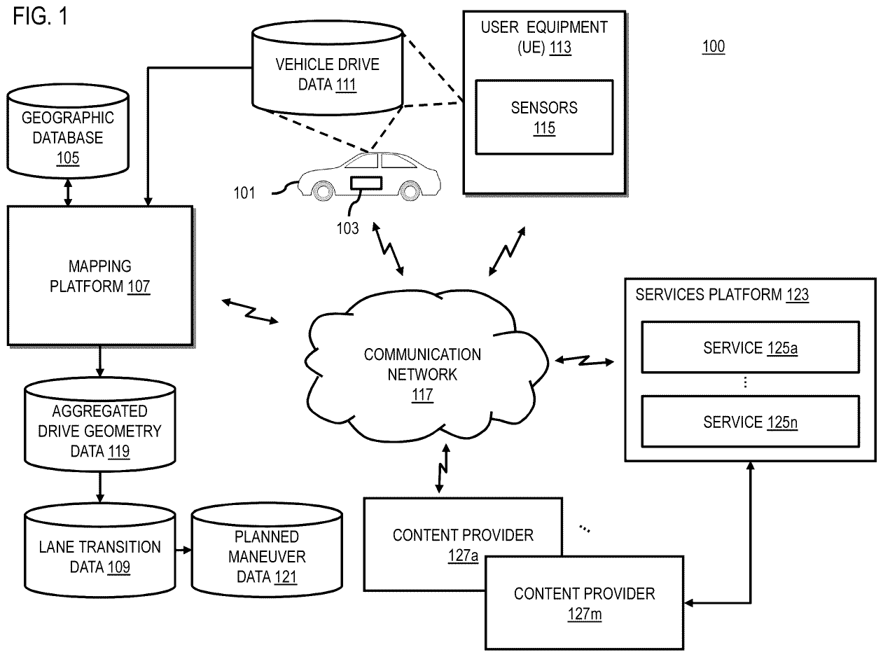

FIG. 1 is a diagram of a system capable of providing behavioral driven lane transitions from crowd sourced sensor data, according to one example embodiment. For driver assistance or autonomous operation, a vehicle (e.g., a vehicle 101 via onboard systems 103) generally plans vehicle controls (e.g., speed, steering, expected lane transitions) ahead of time and based on various situations (e.g., planned maneuvers, approaching intersections, etc.). Lane transition information (e.g., data on where and/or how vehicles 101 move from one lane of a road to another lane) may help determine road/lanes areas where complex or dangerous situations occur. For example, perhaps in an area of high lane transitions (e.g., areas where the number or rate of lane transitions are above a threshold number or rate), assisted or autonomous driving of a vehicle 101 may require or otherwise request manual driver input for safe operation. High lane transition areas may also indicate where a single expected drive path is not suitable. In addition, lane transition areas may indicate dangerous situations where other vehicles may enter the driver's path.

Maps (e.g., digital map data of the geographic database 105) and on-board sensors currently provide static physical lane geometry, and/or information on the presence of other vehicles. However, a static geometry map, or on-board sensors may not provide prediction of driver behavior (e.g., is the vehicle 101 in the next lane likely to merge into the driver's current lane). In other words, the map (e.g., digital map data of a geographic database 105 available via a mapping platform 107) may contain information on physical lane geometry, but geometry data in maps are traditionally static (e.g., fixed at the point of the last map update). On-board sensors 115 of vehicles 101 may provide some dynamic data on the objects in the environment (e.g., other vehicles), but these sensors 115 traditionally are not predictive of the expected lane transition behaviors of other drivers or vehicles. On-board systems 103 for driver assistance or autonomous operation of a vehicle 101 may need this lane transition predictive information to plan lane changes or other maneuvers that span multiple lanes or to determine when the vehicle 101 is traveling in potentially risky areas where there may be a higher than average number of other vehicles 101 that are making lane changes.

To address the technical challenges associated with the above process, the system 100 of FIG. 1 introduces a capability to aggregate a multitude of crowd sourced sensor drives (e.g., vehicle drive data 111) to provide average driver lane transition behavior for assisting on-board autonomous driver assistance (e.g., on-board systems 103). In one embodiment, the system 100 captures locations of lane transitions from crowd sourced data comprising drive paths from multiple vehicles 101 traveling in a given area of a road network (e.g., vehicle drive data 111). Each aggregated drive path consists of compute lane transition scores indicating the rate of drives that depart or enter the path (e.g., movement or indicating of a movement of a vehicle 101 from one lane of a road to another). These lane transition scores may consist of or otherwise be based on the rate (e.g., a count to f the number of drives with a lane transition versus total drives of the path) of vehicles that crossed a lane marking (e.g., in some embodiments, stratified based on one or more attributes), deviated to another path, and drives that used turning signal blinkers. In some embodiment, that lane transition score are stratified by attributes such that vehicle drive data 111 of one or more selected attributes (e.g., drives with the presence of traffic versus non-presence of traffic, daytime versus night time, etc.). The computation of these scores consists of driver behavior (e.g., observations of these behaviors captured as vehicle drives), independent of any road rules. This information (e.g., lane transition data 109) is then attached to a map (e.g., road lanes, intersections, maneuvers, etc. represented in the geographic database 105), so that future vehicles may use the lane transition data 109 to plan maneuvers on board (e.g., planned maneuver data 121).

In other words, the system 100 aggregates a multitude of crowd sourced sensor drives (e.g., vehicle drive data 111) to create a lane transition profile of expected lane changes (e.g., lane transition data 109), e.g., including data on where vehicles 101 from different paths or lanes may merge or depart with other lanes. These aggregated lane change attributes may be attached to a map of the geographic database 105. Such that an autonomous/assisted vehicle 101 using the geographic database 105, may plan, ahead of time, if a situation is dangerous, be on the lookout for nearby vehicle maneuvers, return control to the manual driver, change speed, etc. In addition, the lane change behavior may help determine where the driven vehicle 101 should begin/end a planned lane change maneuver of its own.

In one embodiment, the process for aggregating crowd sourced sensor data into a lane transition profiles includes one or more of the following steps:
(1) The system 100 collects a multitude of crowd sourced drive paths and sensor data (e.g., vehicle drive data 111). For example, crowd sourced data is available from commercial and private vehicles 101 at a large scale (perhaps millions of drives a day). This sensor data provides an anonymized drive path, with speed; and additional attributes; if other vehicles 101 are present, day/night, construction, turn signal usage. In addition, such sensor data may also capture signs, poles, traffic signals, road surface markings, lane markings, road edges, etc. The vehicle drive data 111, for instance, can be gathered as real world sensor drive paths (e.g., vehicle drive data 111) from vehicles 101 and/or user equipment (UE) devices 113 via respective sensors 115 (e.g., positioning sensors such as Global Navigation Satellite System/Global Positioning System (GNSS/GPS)).

(2) The system 100 aligns the collected drive paths and/or sensor data to lane level accuracy. In one embodiment, the alignment can be based on a recursive aggregation and alignment of detected features (e.g., signs, poles, lane markings, etc.) based on their geo-locations.

(3) The system 100 clusters the drive segments which are driven at the same location/path and with the same maneuvers. Such that, for any path location, the system 100 has a multitude of sensor drives that define the specific location.

(4) The system 100 aggregates the geometry of the paths to reduce the multitude of paths to one path per lane, and per maneuver (e.g., lane change, ramp exit, intersection turns, etc.) to create aggregated drive geometry data 119.

(5) The system 100 aggregates the attributes for each drive path segment (say every 1 m meter or any other designed interval along the drive path). In one embodiment, the system 100 aggregates the occurrences of lane transitions, and other sensor data that may indicate drive lane transitions, and/or any other indications of potential lane transitions such as but not limited to turn-signal blinker usage (e.g., lane transition data 109). The aggregated paths and lane transition data 109 are defined for each lane, and even for paths that may not be a specific lane (e.g., drivers may often change lanes near an off ramp, or cut a corner when turning).

(6) The system 100 may model multiple lane transition attributes and/or resulting lane transition scores for the same lane, e.g., based on different situational attributes, path geometry transitions, and/or turn-signal blinker usage as described below.
In one embodiment, lane transition scores can be modeled based on situational attributes (e.g., yes/no crossing of any lane marking). Such a lane transition score can also capture the presence, e.g., within 50 m travel or other designated proximity threshold, of the lane mark crossing. By applying the lane transition over an area within this proximity threshold, the lane transition score can be used to indicate “areas” of likely lane marking crossings. By way of example, the lane transition scores based on the crossing of lane markings can be modeled as at least four situations (e.g., left/right and depart/enter):
   Count/rate of vehicles 101 that departed and crossed a lane marking to the LEFT;
   Count/rate of vehicles 101 that departed and crossed a lane marking to the RIGHT;
   Count/rate of vehicles 101 that entered the path by crossing a lane marking from the LEFT; and/or
   Count/rate of vehicles 101 that entered the path by crossing a lane marking from the RIGHT.
In another embodiment, lane transition scores can be modeled based on actual path geometry transitions; such as based on the specific locations where a vehicle 101 departs or enters the path from another path. This lane transition score indicates specific locations where transitions start/end. Similar to above, these can be modeled with at least four situations (left/right depart/enter):
   Count/rate of vehicles 101 that departed from the current path to the LEFT;
   Count/rate of vehicles 101 that departed from the current path to the RIGHT;
   Count/rate of vehicles 101 that entered the current path from the LEFT; and/or
   Count/rate of vehicles 101 that entered the current path from the RIGHT.
In yet another embodiment, lane transition scores can be modeled based on captured turn-signal blinker usage as follows:
   Count/rate of vehicles 101 with an active Left turn signal blinker; and/or
   Count/rate of vehicles 101 with an active Right turn signal blinker.

Essentially, the system 100 (e.g., via the mapping platform 107) creates behavioral driven lane transitions (e.g., lane transition data 109) that indicate where and most drivers appear to make lane transitions or indicate that they are making lane transitions, regardless of the map's physical features. As noted, there may be multiple, different behavioral driven lane transition models based on different environmental and maneuver planning situations (e.g., traffic present/not present). The technical challenges are efficiency, alignment of drives, aggregation (e.g., clustering) of drive paths to determine behavioral driven lane transitions that reflect actual driving, and attaching this data (e.g., lane transition data 109) to the delivered map (e.g., digital map data of the geographic database 105).

In one embodiment, the aggregation is performed with at least lane-level accuracy to determine lane-level vehicle paths and resulting behavioral driven lane transitions in the road network.

By way of example, the usage of the lane transition data 109 (e.g., behavioral drive lane transitions) can include but are not limited to: (1) when a vehicle maneuver is planned (e.g., planned vehicle maneuvers 121), the lane transition scores may assist planning for where to begin/end a lane transition; (2) the lane transition scores can be used to indicate dangerous/complex areas, e.g., where other vehicles may enter/depart the drive lane; (3) the lane transition scores can be used to indicate that a single/optimal aggregated behavior drive path may not be sufficient for automated path planning (e.g., indicate that the use of multiple lanes may be needed); and/or (3) the lane transition scores can be used to indicate where turn signals should be turned on or turned off.

In one embodiment, vehicles 101 and/or UEs 113 designed with sensor data capture collect drives (vehicle drive data 111) from a multitude of vehicles 101 (e.g., perhaps millions of drives a day). These drive paths can be anonymized by the vendor/source (e.g., an automotive original equipment manufacturer (OEM)), and delivered to mapping platform 107 for sensor aggregation, conflation, and derivation. With the result being a consensus of how an average driver may have behaved, given many drives at the same location. In some embodiments, the mapping platform 107 can aggregate vehicle drive data 111 directly from vehicles 101 over a communication network 117.

By way of example, the vehicle drive data 111 can include vehicle drives or source drives that represent vehicle trajectory data collected by the sensors 115 of the vehicles 101 and/or UEs 113. Vehicle trajectory data is a type of data that records the location, direction, speed, and/or time of a vehicle as it moves over a road network. Some examples of vehicle trajectory data include but are not limited to: (1) a sequence of latitude and longitude coordinates that indicate the position of a vehicle at different timestamps; (2) a polyline that shows the shape and direction of a vehicle path on a map; (3) a set of attributes that describe the speed, duration, frequency, or events of a vehicle movement along a path; and/or (4) any other equivalent data. The vehicle drives can also include detections of features (e.g., road signs, poles, lane markings, road furniture, on-road objects, objects within detection range of the road, etc.) that are present on or within proximity of the road on which the vehicle 101 is driving.

Source drives (e.g., vehicle drive data 111 can be processed by the mapping platform 107 using cloud-based streaming processing or equivalent on a map tile-by-tile basis. For example, typically processing a large number of drives for each world Tile (e.g., Earth is subdivided into tiles at various scales—e.g., smaller and smaller tiles). Initially, each drive can be fitted with a Kalman filter to create a smooth vehicle path that follows both the relative motion of the vehicle 101 and the GNSS or other positioning observations.

However, based on GNSS accuracy, the resulting drives may not be high enough accuracy to determine lane level alignment. Therefore, in one embodiment, for each tile, all the drives are aligned to each other by optimizing the alignment of many different observations, such as signs, poles, lane markings, etc.

The result is that the multitude of drives overlap, with enough accuracy, that the system 100 can aggregate the drive paths that overlap with enough certainty, such that the system 100 may model behavior-based drive path geometry (e.g., aggregated vehicle drive geometry data 119). The geometry data 119 may be defined differently for different maneuvers (e.g., lane changes, intersection turns, merge, split, behavioral speed, etc.)

With the aggregated vehicle drive geometry data 119 defined, the system 100 has an association of each drive path node and segment, along with which drives contributed to each node and segment. The system 100 then gathers the various driver behavior (e.g., stops, speeds, maneuvers, etc.), and models statistics such as average, mean, minimum, maximum, standard deviation (StdDev), etc.) of the behavior for each segment. For lane transition data. 109, the system 100 can aggregate the lane changes and type of lane change, for each drive path to determine the average lane transition score driven by observed drives along different segments of a road network.

In one embodiment, the system 100 also qualifies different lane transition scores based on one or more attributes, such as lane transitions when no other traffic is present or not present, lane transitions when a maneuver is performed, lane transitions at night versus daytime, and/or the like.

In summary, the various embodiments of the system 100 described herein provide for aggregation of crowd sourced vehicle sensor data (e.g., vehicle drive data 111) to model lane transitions based on driven behavior of many individual drives (e.g., referred to herein as behavioral driven lane transitions); such that a model of where observed vehicles make lane transitions (e.g., lane transition data 109) can be created. As opposed to relying on mapped road topologies for modeling lane transitions, the system 100 models lane transitions based on actual driven speeds without needing to reference mapped features. These lane transition profiles can also be correlated with various contextual attributes. The system 100 involves capturing a large volume of actual drives (e.g., sensor data collected from potential thousands, hundreds of thousands, or even millions of drives per day), aligning the drives to remove position uncertainty, and capturing multiple drive pass at a lane-based (sub-meter) overlap of multiple drives. Then aggregating drive paths (e.g., aggregated vehicle drive geometry data 119), and finally aggregating lane transition behavior from all overlapping drives (e.g., lane transition data 109).

The aggregated behavioral drive lane transition data 109 may be attached to an on-board map (e.g., digital map data of the geographic database 105), such that vehicles 101 using such a map may make decisions ahead of time for the optimal vehicle lane transitions (e.g., planned maneuver data 121). Different lane transition models or scores may be based on a multitude of behavior criteria, such as when there are other vehicles ahead of the vehicle, when there is on-coming traffic, when there are parked cars on the road, etc.

In one embodiment, the lane transition data 109 and/or planned maneuver data 121 can be provided as an output from the mapping platform 107 and/or any other equivalent component of the system performing equivalent functionality. The output (e.g., lane transition data 109 and/or planned maneuver data 121) can be stored as an attribute of corresponding locations represented in the digital map of the geographic database 105. In addition or alternatively, the output can be provided or otherwise made accessible to a services platform 123, one or more services 125a-125n (also collectively referred to as services 125), and/or one or more content providers 127a-127m (also collectively referred to as content providers 127). By way of example, the services platform 123, services 125, and/or content providers 127 can be location-based services (e.g., mapping service, navigation service, autonomous driving services, vehicle assist services, etc.) that can use the output (e.g., lane transition data 109 and/or planned maneuver data 121) to perform one or more functions.

The various embodiments described herein for provide for several technical advantages including but not limited to:
(1) Provides autonomous or driver assisted vehicles 101 with pre-planning of drive trajectory, speed, steering, etc., based on expected lane transitions for the driven vehicle and from lane transitions from other lanes, in different situations and conditions.
(2) Provides autonomous or driver assisted vehicles 101 with planning of where to make lane transitions.
(3) Provides driver assisted vehicles with pre-planning of risk areas, based on behavior drive lane transitions (e.g., by identifying areas where there are a high number of lane transitions—number of lane transitions above a threshold value).

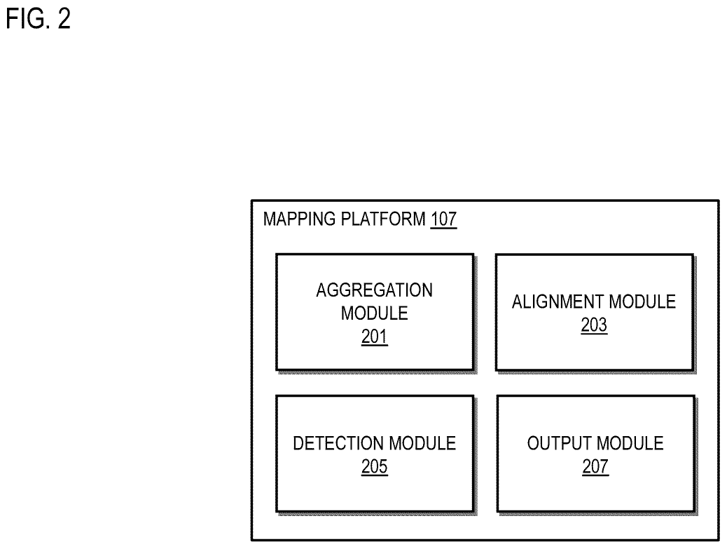

FIG. 2 is a diagram of components 201-207 of a mapping platform 107 capable of providing behavioral driven lane transitions from crowd sourced sensor data, according to one example embodiment. As shown, the mapping platform 107 includes one or more components for providing behavioral driven lane transitions from crowd sourced sensor data according to the various example embodiments described herein. In one example embodiment, the mapping platform 107 includes an aggregation module 201, an alignment module 203, a detection module 205, and an output module 207. The above presented modules and components of the mapping platform 107 can be implemented in hardware, firmware, software, circuitry, or a combination thereof. Though depicted as a separate entity in FIG. 1, it is contemplated that the mapping platform 107 may be implemented as a module of any of the components of the system 100 (e.g., a component of the services platform 123, services 125, content providers 127, vehicle 101, UE 113, and/or the like). In another embodiment, one or more of the modules 201-207 may be implemented as a cloud-based service, local service, native application, circuitry, or combination thereof. The functions of the mapping platform 107 and modules 201-207 are discussed with respect to the figures discussed below.

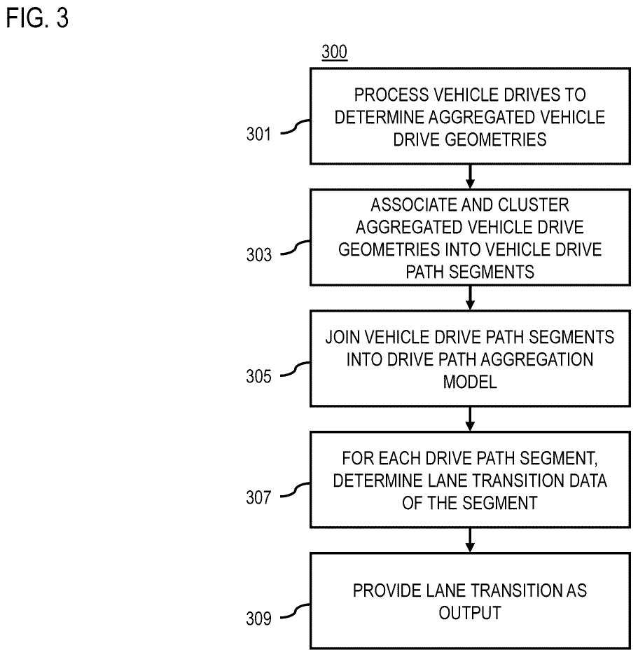

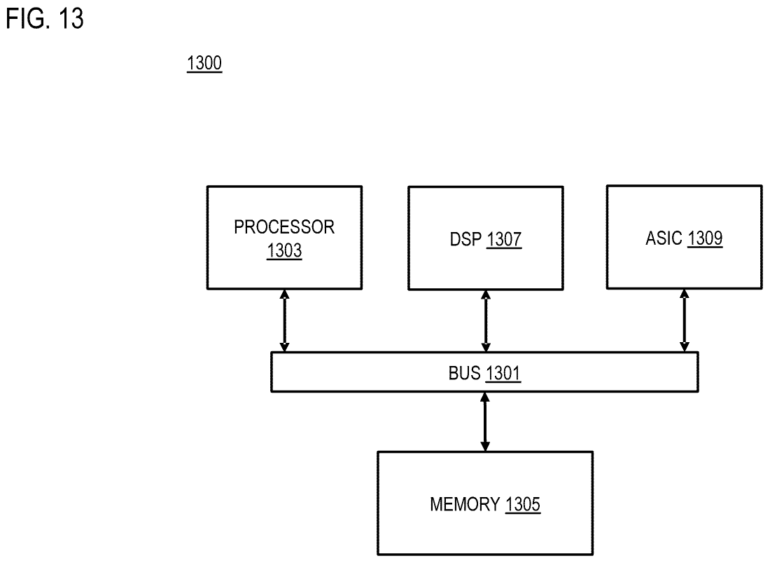

FIG. 3 is a flowchart of a process 300 for providing behavioral driven lane transitions from crowd sourced sensor data, according to one example embodiment. In various embodiments, the mapping platform 107 and/or any of the modules 201-207 may perform one or more portions of the process 300 and may be implemented in, for instance, a chip set including a processor and a memory as shown in FIG. 13. As such, the mapping platform 107 and/or any of the modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

As an overview, one goal of the process 300 is to gather crowd sourced sensor drives, and aggregate various lane transition scores along each potential drive path (e.g., to create a lane transition profile or model). First, the drive paths in the vehicle drive data 111 (e.g., drives in the map tile of interest) versus lane markings are analyzed to determine the locations where the drive path crosses any lane-marking (e.g., crossing right or left over the lane marking). These drive points are flagged as lane-transitions. In one embodiment, all drive-points within a threshold proximity or distance along the segment (e.g., 50 m or any other designated) are flagged as nearby a lane change (e.g., with before/after and left/right status).

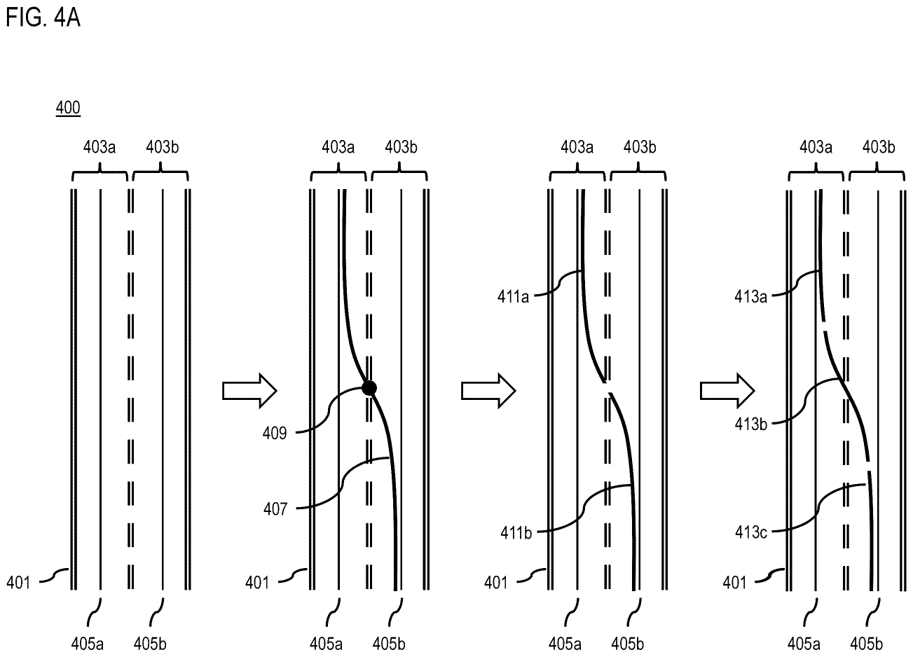

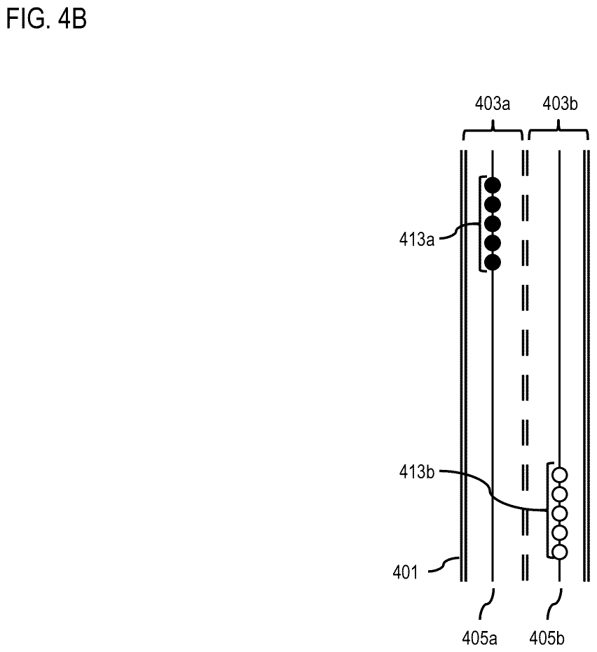

FIGS. 4A and 4B are diagrams illustrating an example of analyzing drive paths versus lane markings, according to one example embodiment. In example 400 of FIG. 4A, a road segment 401 includes two lanes 403a and 403b. Vehicle drive data 111 is obtained for the road segment 401 and processed to determine that there are two aggregated vehicle drive path geometries 405a and 405b corresponding to each of the lanes 403a and 403b. At least one vehicle drive 407 is identified as crossing from the right aggregated path 405b (e.g., corresponding to the right lane 403b) to the left aggregated path 405a (e.g., corresponding to the left lane 403a) at lane crossing location 409 (e.g., a drive/location point in the drive 407 that corresponds to where the drive 407 performs a right-to-left lane crossing).

The drive 407 is then divided at the lane crossing point 409 into a first drive segment 411a that includes drive points within plus (+) threshold proximity (e.g., +50 m) of the lane crossing point 409 and a second drive segment 411b that includes drive points within minus (−) threshold proximity (−50 m) of the lane crossing point 409. The lane transition data for the first drive segment 411a is assigned as “lane-FROM-Right” status, and the second drive segment 411b is assigned as “lane-TO-Left” status.

In one embodiment, the resulting lane transition data can be assigned to map data (e.g., geographic database 105) by map-matching the geo-locations of the drive 407 to the mapped lanes 403a and 403b of the digital map data (e.g., using any known map matching technique including but not limited to path-based map matching). In this example, the drive 407 is divided into drive segment 413a which is map-matched to lane 403a, drive segment 413b is between the two lanes 403a and 403b and not matched to any of the lanes 403a or 403b, and segment 413b which is map-matched to lane 403b. As shown in example 420 of FIG. 4B, because drive segment 413a falls within drive segment 411a which has lane transition data indicating “lane-FROM-Right” status, the mapped location points of lane 403a in the geographic database 105 that correspond to drive segment 413a are updated with a map attribute indicating that they are “lane-FROM-Right” status. Similarly, the mapped location points of lane 403b in the geographic database 105 that correspond to drive segment 413b are updated with a map attribute indicating that they are “lane-TO-Left” status because drive segment 413b falls within drive segment 411b.

In one embodiment, the drives in the vehicle drive data 111 can be registered to each other to reduce the position uncertainty to sub-lane-level accuracy. This is performed so that the aggregation module 201 may aggregate drives in the same lane/path with each other. For example, Each crowd sourced drive is registered (e.g., local alignment) with other drives using the crowd sourced features (e.g., signs, poles, lane marking, etc.). The features of each drive are associated with the same feature of other drives (clustering). Then each drive's path is corrected such that the drives features are optimized to the (weighted) centroid of the feature clusters. Alternately, an existing ground truth or map may be used to localize each drive.

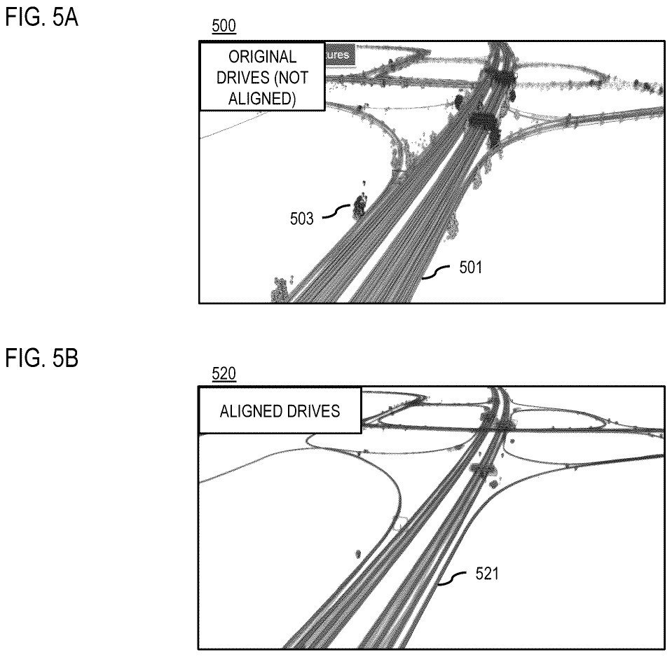

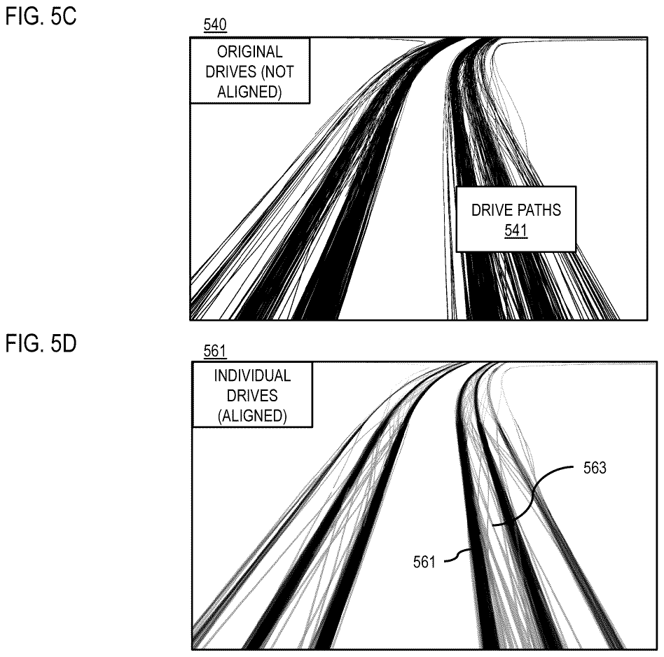

FIG. 5A illustrates an example 500 of individual source drives 501 (e.g., indicated by each separate line) without alignment and showing locations of features 503 (e.g., signs, poles, etc.) detected on each drive. In one embodiment, the detected features 503 can be used for alignment as described further below. Because the example 500 is shown without alignment, individual drives can be seen to be offset slightly in the horizontal and vertical planes because of inherent errors in the positioning technology used to capture each drive (e.g., GNSS). With lane transition data 109, a future driven (assisted/automated/advised) vehicle 101 may have advanced knowledge of how to make lane transitions in a way that more accurately reflects actual drives or in areas where lane information is not available or otherwise not detected. Although the mapped lane topologies are available, the behavioral drive lane transitions provide for more lane transition control of vehicles 101. Behavioral driven lane transitions may be defined for different maneuvers, within intersections, at split/merge points, day versus night, traffic versus no traffic, etc.

FIG. 5B illustrates an example 520 after the source drives are aligned (e.g., using the recursive alignment processed described further below). In example 520, the lines representing individual drives 521 are more aligned such that each drive 521 has less offset from each other.

The alignment enables the offset to be less than a lane width so that lane-level determination of behavioral driven lane transitions can be performed. For example, FIG. 5C illustrates another example 540 of unaligned drive paths 541 that can be used for determining lane transitions. FIG. 5D is an example 560 that continues the example 540 of FIG. 5C and shows the drive paths 541 after drive alignment according to the various embodiments described herein. In example 560, the darker band of vehicle drives (e.g., band 561) indicate clusters of drives that align with path geometries that correspond to lanes traveled in a road network work. Then drives (e.g., drive 563) that traverse between these darker bands represent the vehicle trajectories that are performing lane transitions to move between two path geometries.

The process 300 then aggregates determined lane transitions at the lane, maneuver, and condition level. With this aggregated behavioral drive lane transitions, a future driven (assisted/automated/advised) vehicle 101 may have advanced knowledge of how to perform lane transitions based on driven behavior.

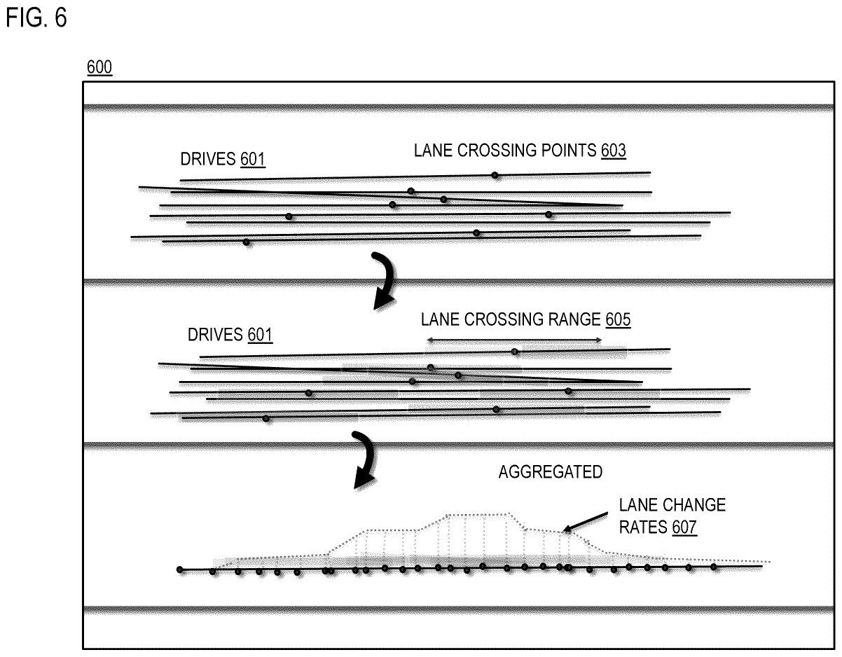

FIG. 6 is a diagram illustrating an example 600 of aggregation of lane change rates, according to one example embodiment. After alignment, drive paths (drives 601) are divided into short segments and clustered such that overlapping segments of different drives are aggregated into combined segments. These segments may represent a unique lane or maneuver. The segments are then re-assembled into chains of connected aggregated segments (e.g., aggregated path polylines). The aggregated polylines then are compared to the original drive paths, and any geometric departure/entry (e.g., switch from one aggregated path to another at one or more lane crossing points 603) is flagged. As described above, lane crossing ranges 605 can be assigned to one or more drive-path segments based on proximity distance of vehicle drive points from lane crossing points 603 (e.g., location of lane crossing points 603±threshold proximity such as but not limited to ±50 m).

Finally, a lane transition attribute (e.g., average attribute) set is computed for each aggregated drive-path segment. Examples of the attribute set include but is not limited to an average speed, or average lane-change rate, average blinker rate, etc., or any lane transition score computed therefrom to represent a count or rate of lane transitions along different drive-path segments or drive points contain therein (e.g., lane change rates 607). In example 600, the lane change rates 607 are represented the height of a line above a representation of the corresponding road lane segment with higher height values reflecting higher lane change rates (or equivalent lane transition counts, lane transition scores, etc.).

The following steps provide more details of the process 300.

In step 301, the aggregation module 201 processes vehicle drive data 111 to determine a plurality of aggregated vehicle drive geometries (e.g., aggregated vehicle drive geometry data 119). The vehicle drive data 111 is determined using one or more sensors 115 of one or more vehicles 101 and/or UEs 113. In one embodiment, the vehicle drive data 111 can be collected from one or more data sources. One example data includes but is not limited to personal vehicles 101. For example, personal vehicles 101 from certain vendors (e.g., OEMs) contain on-board sensors 115 that track a vehicles path and speed, and track objects or features along the road, such as but not limited to signs, poles, road markings, lane marking, road boundary, traffic signals, other traffic, turn signals, lane crossing, and various environmental situations. Millions of these drives are uploaded to the cloud and ingested into the cloud processing system of the mapping platform 107. These are referred to herein crowd sourced sensor drives.

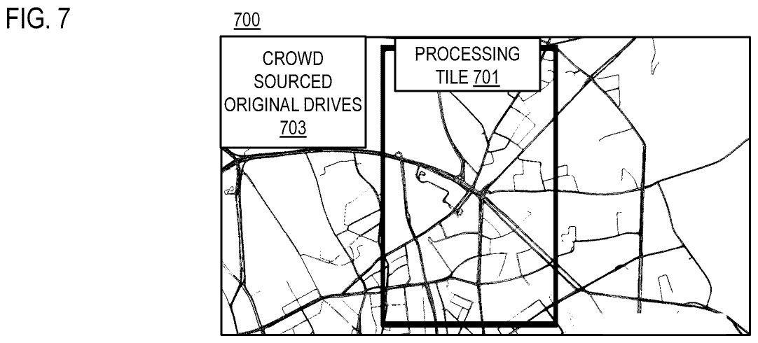

The drives are assigned into corresponding map tiles (e.g., Level 14 subdivision a standard map tile representation of the Earth) which are about 2 km×2 km and are continuously collected over a specific range of dates. Each tile may contain thousands of drives or more. The package of tile drives is delivered to the aggregation module 201 of the mapping platform 107 processing stream. FIG. 7 is a diagram 700 of source drives captured for an example map tile 701, according to one example embodiment. In this example, the area of the map tile 701 is used to divide the crowd sourced original drives 703 (e.g., a collection of multiple drives captured from vehicles traveling over the road network in the geographic area of interest) in units for separate processing to determine lane transitions within map tile 701. This can provide for greater efficiency of processing by subdividing the crowd sourced original drives 703 is smaller units that can be processed individually or in parallel.

In step 303, the alignment module 203 associates and clusters the plurality of aggregated vehicle drive geometries into a plurality of vehicle drive path segments. The step, for instance, is referred to as aggregation. In one embodiment, the tile (e.g., map tile 501) of drives is processed as a group in the aggregation process, which reduces the data into an aggregate, or consensus of how all the drives see a single model. For example, if there are 500 drives that traverse the same lane, at the same point, the aggregated output is one point. This aggregated point contains the consolidated attributes of all the drives, such as the where stops occur, and average speed of all the drives at the point along the lane path. Likewise, all other contextual attributes, such as but not limited to date, day-night, construction, maneuver type, etc. are aggregated as well. In addition, all detected features associated with the drives such as but not limited to the signs, poles, lane-markings, etc. are also aggregated into a single representation of the consensus of all drives. Noise, or outliers, may be removed if observations are not consistent, or randomly observed.

The aggregation may occur without the aid of existing data; such that only the incoming crowd-sourced drive information is used, without any bias to a pre-existing map (e.g., geographic database 105). In other cases, a pre-existing map (e.g., geographic database 105) may be used to assist association.

One goal of aggregation is to gather information about the same object or same behavior from each drive. The challenge is to determine which features from one drive are associated with the same feature of another drive. If the system 100 has perfect data (e.g., perfectly accurate drive locations and feature detection locations), this might be straight forward. However, there are always sensor noise and uncertainty, such as geo-location accuracy, false sensor readings, sensor uncertainty, adverse environmental conditions (e.g., blocked view due to traffic or weather), and/or the like. There may be many of the same real-world features (e.g., similar signs) in the same location, such that the sensor uncertainty may be larger than the distance between the real-world features. With this uncertainty, correct association between different drives may not be possible. For example, if the GNSS geo-location is only precise to 5 m, the aggregation module 201 might not be able to associate drives into the correct lane. In addition, for drives paths, there is not a single physical drive path, and each drive may take slightly different trajectory, such that association many be challenging.

In one embodiment, to assist in aggregation, the alignment module 203 can perform an aggregation alignment of a plurality of vehicle drives in the vehicle drive data based on one or more features detected during the plurality of vehicle drives by the one or more sensors of the one or more vehicles. One step to making correct associations between different drives is to reduce the drive path uncertainty. Since sensor data may have significant positional and detection uncertainty, the drives in the tile are first aligned using detected features (e.g., physical objects, such as but not limited to signs, poles, lane-markings, etc.).

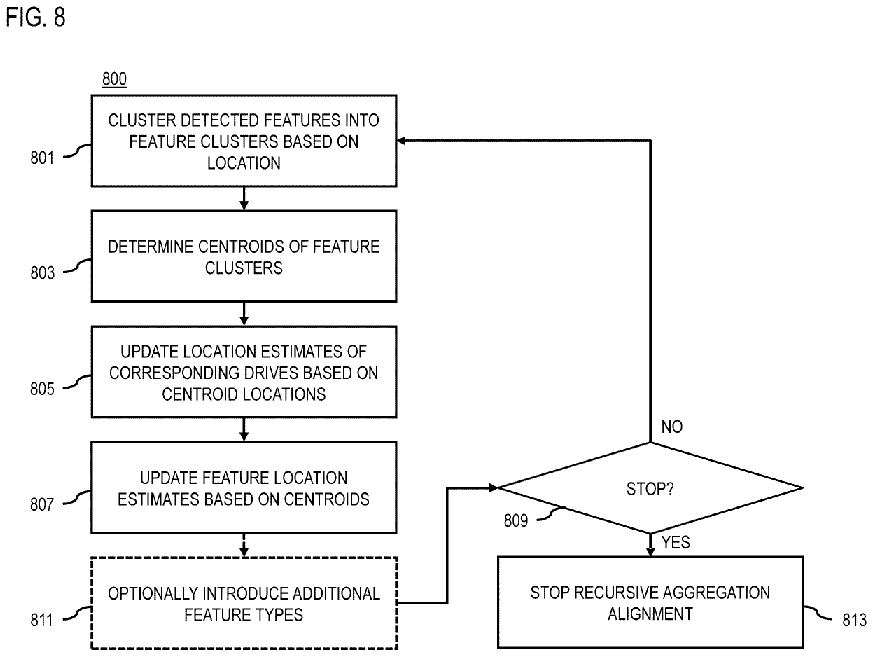

An iterative approach of association, clustering, and alignment is performed. An example of this iterative approach is shown in FIG. 8 which is a flowchart of a process for aggregation alignment of source drives, according to one example embodiment. In various embodiments, the mapping platform 107 and/or any of the modules 201-207 may perform one or more portions of the process 800 and may be implemented in, for instance, a chip set including a processor and a memory as shown in FIG. 13. As such, the mapping platform 107 and/or any of the modules 201-207 can provide means for accomplishing various parts of the process 800, as well as means for accomplishing embodiments of other processes described herein in conjunction with other components of the system 100. Although the process 800 is illustrated and described as a sequence of steps, it is contemplated that various embodiments of the process 800 may be performed in any order or combination and need not include all of the illustrated steps.

In step 801, the alignment module 203 clusters the one or more detected features into one or more feature clusters based on one or more feature geo-location estimates of the one or more detected features. For example, the alignment module 203 first uses the provided geo-location estimate of the paths (e.g., Kalman fused global GNSS and relative motion), and all the detected features (e.g., poles, signs, etc.) are attached to the initial estimate. In one embodiment, the clustering of the one or more detected features is further based on or more attributes (e.g., shape, size, color, etc.) of the one or more detected features. Typically, each feature (e.g., sign, poles, etc.) are attached to the drive paths, such that an update to the drive path, also updates the position of each attached feature. The alignment module 203 then associate non-ambiguous (e.g., standalone signs, without neighbors, high confidence observations only) between drives, cluster these associations, and aggregate the multiple drive observations into a single consensus of the feature. For example, the one or more detected features are features that are classified as non-ambiguous based on (1) the one or more detected features being a standalone feature with no other feature being detected within a threshold proximity, or (2) the one or more detected features having a feature detection confidence above a threshold confidence

In step 803, the alignment module 203 determines respective one or more centroids of the one or more feature clusters. More specifically, the centroid location of the aggregated feature is used to estimate how each individual drive would need to move to align with the centroid. This is performed for all non-ambiguous features (poles, signs, signals, etc.). Given all the estimated path alterations, a new, entire, drive path is optimally modeled for each drive. In one embodiment, the associations are based on as many attributes as possible, not just geo-location. For example, a sign's width and height, sign type, sign, shape, sign heading, etc. may all be used to help associate each drive's features with the same physical features in other drives.

In step 805, the alignment module 203 updates geo-location estimates of one or more corresponding drives of the plurality of vehicle drives based on the one or more centroid geo-locations of the respective one or more centroids. For example, the alignment module 203 can determine the difference between the centroid location of a given feature and the geo-location estimate of the same feature in a drive. The difference between the two locations (e.g., in the x, y, and z axes) can be applied to adjust the geo-location estimates of each point in the drive being evaluated.

In step 807, the alignment module 203 also updates the one or more feature geo-location estimates based on the one or more centroid geo-locations. For example, after each iteration, the alignment module 203 recomputes new feature locations for all the detected features (e.g., signs, poles, etc.) as defined by the path updates. The alignment module 203 then iterates this procedure (step 809), with the expectation that each iteration provides better alignment, such that the features that were previously ambiguous (using the original paths), may now be associated correctly with the improved paths.

Eventually, more features (such as lane-markings) are introduced to refine the path alignments (step 811). For example, one or more additional detected feature types or features (e.g., lane markings) are introduced after completing a designated number of recursions of the aggregation alignment. Each iteration pass includes an incremental count of available features, until we have a semi-optimal path for every drive (e.g., end condition is reached such as achieving lane level alignment accuracy of 5 m or better), such that the common features between drive align. In step 813, once the end condition is met, then the alignment module 203 ends the recursive aggregation alignment. For example, the aggregation alignment is iterated recursively until a threshold number of available features align between the one or more corresponding drives.

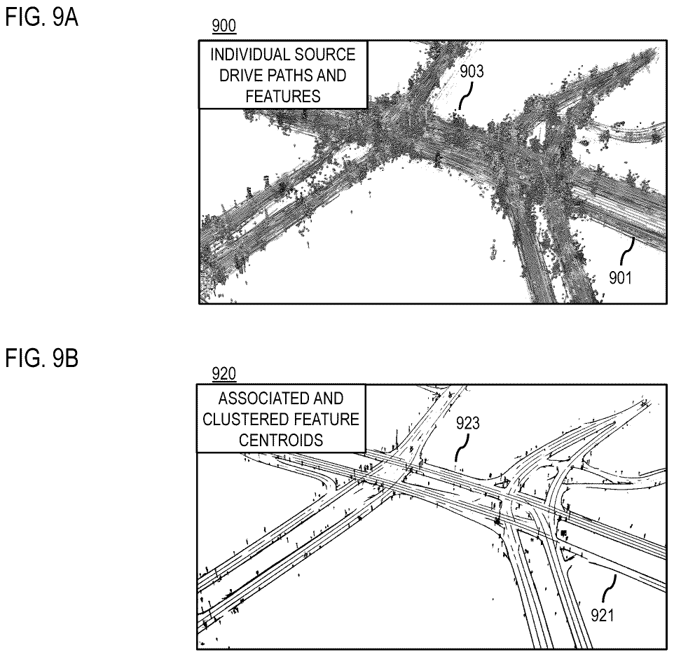

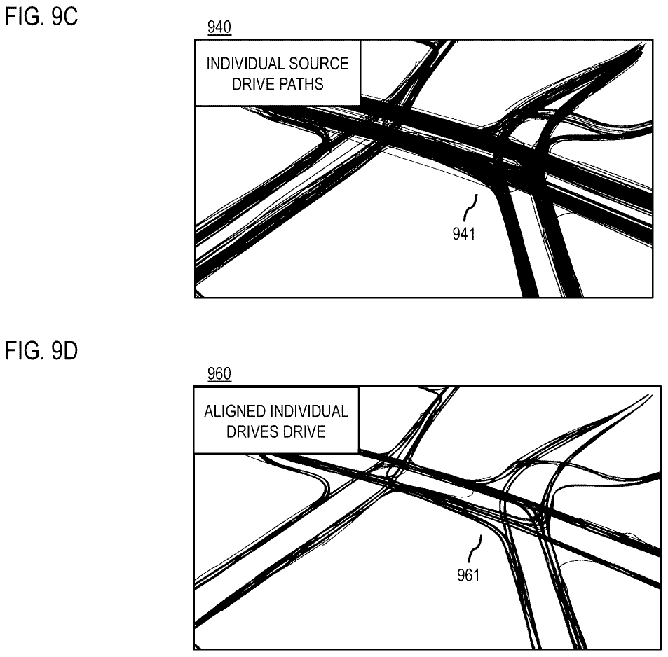

One example embodiment of the alignment process is summarized as follows:
(1) Association=Compare geolocation proximity, width/heigh dimension match, sign/pole type match, shape match, heading match. As previously described, the associating of the aggregated vehicle drive geometries can be by associating a proximity, a heading, a future maneuver, a past maneuver, or a combination thereof the one or more vehicles. The alignment module 203 applies a new association for every pass. FIG. 9A illustrates an example 900 of original sensor drives with feature detections, according to one example embodiment. In the example 900, example raw individual source drive paths 901 and feature detections 903 (e.g., a detected pole) are shown.
(2) Clustering=Use Association to group each drive observations of the same physical feature (e.g., pole feature 903 of FIG. 9A). Compute the centroid consensus. FIG. 9B illustrates an example 920 in which the drives 901 of FIG. 9A have associated in aggregated drive geometry 921 and the features 903 have been clustered into feature clusters 923. This centroid consensus (e.g., centroid of each feature cluster 923) location is now the goal for each drive to achieve for the location of this feature.
(3) Iteration=Apply steps 1 and 2 for all features in the tile, and for all drives.
(4) Choose which clusters are non-ambiguous (e.g., high confidence that association is correct), and ignore all others.
(5) Recompute each drive (full drive) such that the new drive path's features optimally match the clustered centroids.
(6) Update all feature locations of each drive, given the new drive paths.
(7) Inject additional refinement features, such as lane markings (we need to wait for several passes, until alignment is good enough to correctly associate close together lane-markings)
(8) Repeat steps 1-7.

This aggregation alignment process 800 results in an aggregated vehicle drive path geometry with drives optimally aligned. FIG. 9C illustrates an example 940 showing the original individual source drives 941 before alignment according to the process 800. FIG. 9D illustrates an example 960 of an aggregated drive path geometry 961 aligned using the process 800. For example, this aligned aggregated drive path geometry 941 (e.g., aligned using drive features, such as sign and poles) can now be used to distinguish lane level association. As previously described the aggregated drive path geometry 941 is a single representation (e.g., a node segment representation with the nodes every designated distance, at intersections, etc.) of the drive paths aggregated to create the geometry 941.

Next, process 800 returns to the process 300 of FIG. 3 to perform further association, cluttering, and aggregation of drive path geometry and behavioral driven lane transition determination. For example, now that the drive paths (and attached features) are spatially aligned relative to each other, the alignment module 203 can now associate features between drives. In this case, one goal is the association of overlapping drive path segments between drives. The alignment module 203 applies a similar association and cluster as the above alignment passes. However, the alignment module 203 clusters all the attributes attached to each drive path node/segment, such as lane change locations. In addition, the association is more complex for drive path association, since the alignment module 203 has to take into account different maneuvers and trajectories, not just spatial proximity. For example, the alignment module 203 may not want to aggregate drives that are about to take a highway ramp exit, with drives that are continuing straight along the highway, even if the paths overlap spatially. The drives that are taking the exit may have the same spatial proximity to the continuing highway path; however, the drives taking the exit may have different lane transitions. Therefore, in one embodiment, the alignment module 203 only associates drive sections if they followed the same maneuver. For example, the alignment module 203 can check where the drive was 50 m before and 50 m after (or any other designated distance threshold before or after) the focused segment. In order for other drive segments to associate this this segment, the alignment module 203 checks that the other drives segments match in heading and spatial proximity, and also that the past and future location (e.g., 50 m behind, and ahead, or any other designated distance threshold), also match. In this way, the alignment module 203 can match only drives with the same maneuver pattern.

In step 305, the alignment module 203 joins the plurality of vehicle drive path segments in a drive path aggregation model using connectivity coherence of each vehicle drive path segment of the plurality of vehicle drive path segments, wherein each vehicle drive path segment is represented by a node and a segment. In one embodiment, the alignment module 203 first associates and cluster drive path geometries, by associating on both proximity, heading, and future/past maneuvers. These clusters are created at a short segment level (e.g., any designated distance interval such as 1 m, 5 m, 10 m, etc.), with connectivity preserved, then joined together into continuous paths using the connectivity coherence of each drive. The result is a drive path aggregation model of the physical average drive paths.

This aggregated drive path geometry is the basis for determining behavioral driven lane transitions and/or lane transition scores. Each aggregated drive node and segment now contains a reference to each individual drive that was associated with the node/segment.

In step 307, the detection module 205, for one or more vehicle drive path segments of the drive path aggregation model, determines a set of lane transition attributes from all the associated drives and generate and average of the attributes. For example, the detection module 205 can aggregate a rate vehicles performing a lance change maneuver, a percent of vehicles that perform a lane change maneuver, and/or the like. In addition, the detection module 205 also aggregates all the other attributes, such as date range, environment conditions (traffic present, day-night), maneuver type (lane change, intersection turn). In other words, the aggregated vehicle drive geometries are aggregated based on one or more contextual attributes of the one or more vehicles, one or more maneuvers performed by the one or more vehicles, one or more drives performed by the one or more vehicles, one or more environments in which the one or more drives are performed, or a combination thereof. The detection module 205 may aggregate lane transition scores (e.g., rates, counts, etc.), based on certain criteria, e.g., compute a different lane transition score only from associated drives that perform a specific turn maneuver, or aggregate a separate lane transition score for day versus night, separate transition score for traffic congestion present versus not present.

In other words, in one embodiment, the detection module 205 determines one or more counts of a number and/or rate of the one or more vehicles that cross a lane marking, that depart the one or more drive path segments, that have an active turn signal, or a combination thereof. The detection module 205 then computes a lane transition type and/or a lane transition score for the one or more vehicle drive path segments based on the one or more counts or rates. For example, the lane transition score can be based on an average, mean, minimum, maximum, standard deviation, and/or any other statistical representation of the counts or rates. In one embodiment, the lane transition score can be normalized to a specified range (e.g., 0.0 to 1.0 or any other designated range). In one embodiment, the lane transition can be computed as the lane transition rate for a given path segment (e.g., as a number of transitions divided by the total number of drives at a given drive location, node, segment, and/or any other location or distance interval along the path of interest). A lane transition type, for instance, refers to the specific manner in which a vehicle changes lanes on a roadway. This includes the direction of the transition, such as crossing a lane marking to the left or right, and whether the transition is departing or entering a specific lane (e.g. types such as but not limited to “enter from left,” “enter from right,” “depart to left,” and “depart to right,” etc.).

In one embodiment, the one or more counts/rates include a first count or rate of a number of the one or more vehicles that crossed a lane marking to a left side, a second count or rate of a number of the one or more vehicles that crossed the lane marking to a right side, a third count or rate of a number of the one or more vehicles that entered the one or more vehicle path segments by crossing the lane marking from the left side, a fourth count or rate of a number of the one or more vehicles that entered the one or more vehicle path segments by crossing the lane marking from the right side, or a combination thereof. In addition or alternatively, the one or more counts/rates include a fifth count or rate of a number of the one or more vehicles that departed the one or more drive path segments to the left side, a sixth count or rate of a number of the one or more vehicles that departed the one or more drive path segments to the right side, a seventh count or rate of a number of the one or more vehicles that entered the one or more vehicle path segments from the left side, an eighth count or rate of a number of the one or more vehicles that entered the one or more vehicle path segments from the right side, or combination thereof. In yet another embodiment, the one or more counts/rates include a ninth count or rate of a number of the one or more vehicles with an active left turn signal, a tenth count or rate of a number of the one or more vehicles with an active right turn signal, or a combination thereof

Finally, the detection module 205 has a set of aggregated drive path geometries, with varying lane transition scores, proximities, etc. for each node along each path. These are the behavioral drive lane transitions (e.g., lane transition data 109) which describe how actual drivers drove along each section of road, each lane, each maneuver, and in various conditional scenarios. These profiles may be used to estimate how and where a vehicle should make lane transitions, identify risk areas based on the lane transitions, and/or the like.

In step 309, the output module 207 provides the lane transition data (e.g., lane transition types and/or lane transition scores) as an output. In one embodiment, the output is provided as data for planning at least one lane transition location of a vehicle as discussed above. In another embodiment, the output can be captured into a behavior drive model, and delivered to further stream processes of the mapping platform 107 that may align this data to other sources, other maps, may conflate (join/mix) this behavior model with other sources, and finally derive a customer facing map which contains the driver behavior with associated map links.

By way of example, the output of the lane transition data 109 can be used for functions such as but not limited to: (1) planning a beginning, an end, or a combination thereof a planned lane transition by an autonomous or assisted vehicle 101; (2) determining where one or more other vehicles may enter or depart a drive lane (e.g., to predict potential risk and take actions to mitigate the risk such as requesting manual intervention by a human driver, rerouting, etc.); (3) indicating that multiple drive lanes are to be used for automated path planning (or conversely a single lane may not be sufficient for path planning a route for a vehicle 101); and/or (4) determining where one or more turn signals of a vehicle 101 are to be turned on or turned off.

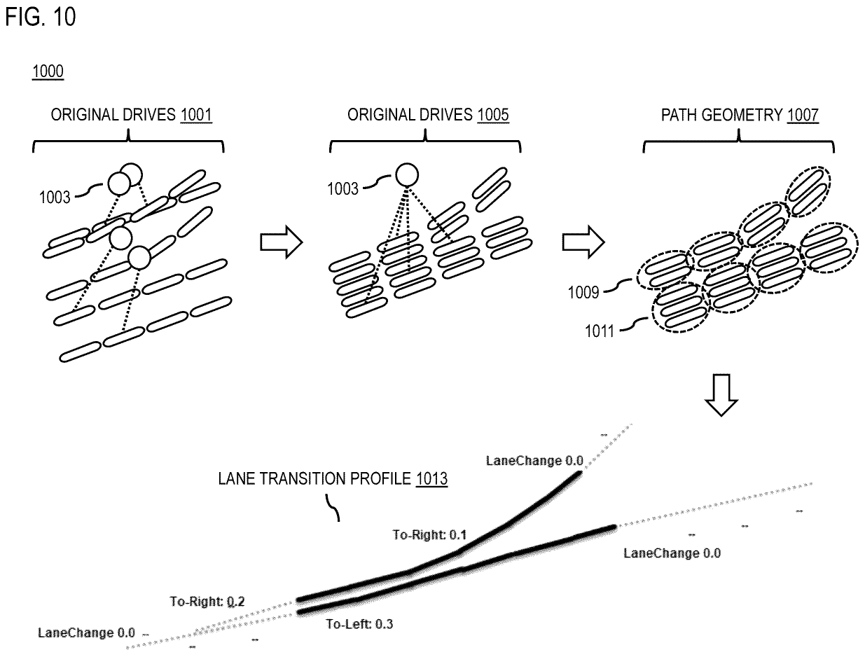

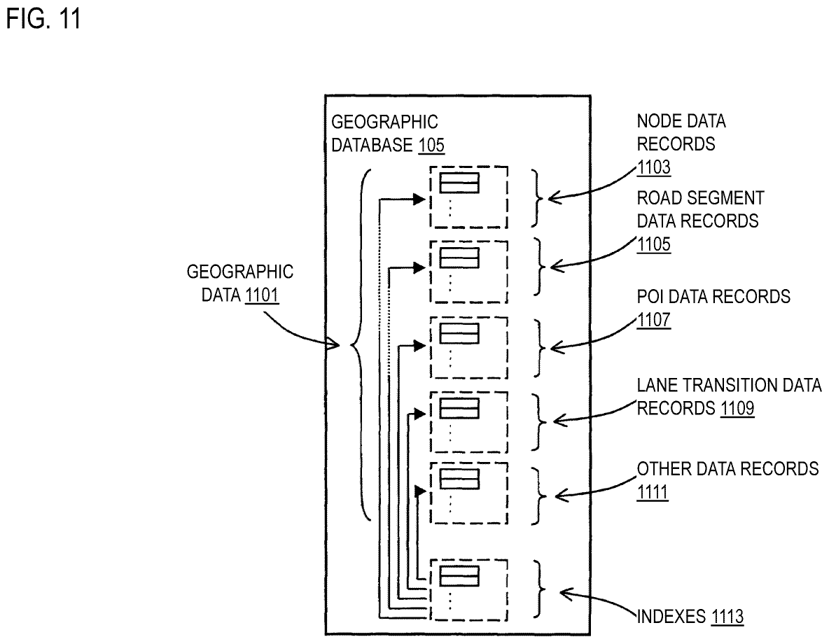

FIG. 10 is a diagram of a simplified example 1000 of aggregating behavioral lane transition profiles, according to one example embodiment. This example is referred to as “simplified” because it illustrates only five example original drives 1001. In practice, the number of drives can be in the thousands or higher. As shown, each of the five original is a vehicle trajectory determined using location sensors 115 of respective vehicles 101. During the drive, feature 1003 was detected and its detected geo-location was recorded respectively in each of the original drives 1001. The original drives 1001 were then processed using the aggregation alignment process described above to align each of the original drives based on the detected feature 1003. After alignment, the resulting aligned drives 1005 are generated so that the detected feature 1003 appears as close to the same location as possible (e.g., as close to the centroid of the clustered geo-locations of the feature 1003 as possible) while correspondingly updating the geo-locations of the vehicle trajectories.

The aligned drives 1005 are then associated and clustered in the segments (e.g., short segments such as 1 m, 5 m, 10 m, etc. segments). The clustering, as previously described, can be based on proximity, heading, and other attributes or factors. For example, when considering a consistency ofupcoming maneuvers, two different clusters 1009 and 1011 are created eventhough the proximity and heading of the segments of the drives in the clusters 1009 and 1011 align. Instead, thetwo different clusters 1009 and 1011 are created duetothe respective maneuvers ahead of each segment is different (e.g., cluster 1009 turning left and cluster 1011 turning right). By way of example, the attributes of the three drives in the cluster 1011 for the first segment are illustrated Table 1 below.

TABLE 1

| Drive in Cluster 1011 | Attributes |
|---|---|
| Drive 1 | Speed = 50 |
| | Daytime |
| | Feb 12: 1:30pm |
| | No traffic present |
| | Maneuver = Right Turn |
| | Construction not present |
| | No stops |
| | Lane-Change-Right 1.0 |
| Drive 2 | Speed = 40 |
| | Daytime |
| | Feb 10: 11:30am |
| | Traffic present |
| | Maneuver = Right Turn |
| | Construction not present |
| | No stops |
| | Lane-Change-Right 0.0 |
| Drive 3 | Speed = 47 |
| | Daytime |
| | Feb 19: 3:30pm |
| | No traffic present |
| | Maneuver = Right Turn |
| | Construction not present |
| | No stops |
| | Lane-Change-Right 1.0 |

The aggregated attributes for this segment of the cluster 1011 is then computed as the consensus of the attributes of the individual drives in the cluster. In this example, the aggregated attributes would be: Speed No Traffic=48.5; Speed With Traffic=40; Daytime; Date Range February 10-February 19; Maneuver=Right Turn; Construction not present; No Stops; Lane-Change-Right 0.66 (e.g., because two of three drives in Table 1 had Lane-Change-Right 1.0 and 0.66 is an average of the three values). The aggregated attributes for each segment of each cluster in the path geometry 1007 can then be used to construct the lane-transition profile 1013 (e.g., a set of lane transition scores along nodes/segments representing an aggregate vehicle path geometry), where the average speed is indicated at each node of the aggregated drive paths (e.g., path geometry 1007). The lane transition profile can also be stratified according to contextual attributes (e.g., lane transition profile with traffic, speed profile without traffic, etc.).

FIG. 9A illustrates an example 900 of aggregated drive path geometry 901 that is a more complex example based on thousands of drives, according to one example embodiment. The drives are processed according to the various embodiments described herein to generate the geometry 901. The geometry 901 is segmented into short intervals with the connection between each segment representing a node. The attributes (including the drive speeds) of the drives in each cluster are then aggregated. The rate and type of lane transitions at each node are then aggregated to create a lane transition profile for the road network of interest (e.g., road network with the corresponding map tile). FIG. 9B illustrates an example 820 of aggregated behavior lane transition profiles 921. In this example, the aggregated behavior lane transition profiles 921 is represented by heights above a corresponding road, where the extent of the height is based on the magnitude of the corresponding aggregated driven lane transition rate. The heights are then connected by lines to show the contours of the lane transition rate variations on the road. It is noted that this representation is provided by way of illustration and not as a limitation. Any other equivalent visualization of the lane transition profiles can be used (e.g., the representation illustrated in FIG. 8C.

In one embodiment, lane transition data 109, including lane change types and rates, can be used by assisted or autonomous driving systems to plan a vehicle 101's upcoming maneuvers, in a way that mimics human drivers. For example, a vehicle 101 can anticipate lane transition probability for both the current lane and from neighbor lanes even though this may not be evident from the physical map-lane geometry. This is because the lane transition data 109 is based on actual driver behavior, as captured by sensors on a large number of vehicles. The system 100 uses this data to create a probabilistic model of where and how vehicle may traverse between lanes, and this model can be used to adjust the vehicle 101's maneuvers in advance. The lane transition data 109 can also be used to differentiate between different vehicle transition behavior for different driving maneuvers, such as encountering oncoming traffic, different speeds, different times of day, etc. The system 100 can recognize the upcoming maneuver and plan the vehicle 101's behavior accordingly. Including predicting dangerous or complex lane change situations. This results in smoother and safer navigation. Additionally, because the system 100 achieves lane-level accuracy for lane transitions, it knows which lane's profile data is relevant to its current position, even on multi-lane roads. This can be used for autonomous lane changes and merging maneuvers. Finally, the system 100 considers contextual attributes or factors like time of day, traffic conditions, and the presence of parked cars to make human-like driving decisions. For example, the system 100 can aggregate separate lane change conditions for driving at night versus during the day.

Returning to FIG. 1, as shown and discussed above, the system 100 includes the mapping platform 107 for providing behavioral driven lane transitions from crowd sourced sensor data. In one embodiment, the mapping platform 107 has connectivity or access to one or more databases for storing the lane transition data 109, aggregated driver geometry data 119, and planned maneuver data 121 determined according to the various embodiments described herein, and as well as a geographic database 105 for retrieving mapping data and/or related attributes for map matching (or storing attributes related to the lane transition data 109, aggregated driver geometry data 119, and planned maneuver data 121). In one embodiment, the mapping platform 107 has connectivity over a communication network 117 to the services platform 123 that provides one or more services 125. By way of example, the services 125 may be third-party services that rely on location-based services created or developed based on the lane transition data 109, aggregated driver geometry data 119, and planned maneuver data 121, etc. generated according to the various embodiments described herein. By way of example, the services 125 include, but are not limited to, autonomous/semi-autonomous vehicle operation, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 125 uses the output of the mapping platform 107.

In one embodiment, the mapping platform 107 may be a platform with multiple interconnected components. The mapping platform 107 may include multiple servers, intelligent networking devices, computing devices, components, and corresponding software for automated detection and/or characterization of road intersections. In addition, it is noted that the mapping platform 107 may be a separate entity of the system 100, a part of the one or more services 125, a part of the services platform 123, or included within the vehicles 101 and/or UEs 113.

In one embodiment, content providers 127 may provide content or data (e.g., including geographic data, vehicle drive data, vehicle path network data, etc.) to the mapping platform 107, the services platform 123, the services 125, and/or the vehicles 101. The content provided may also include any type of content, lane level road topology data, sensor data, map content, textual content, audio content, video content, image content, etc. used for map matching. In one embodiment, the content providers 127 may also store content associated with the mapping platform 107, geographic database 105, services platform 123, services 125, and/or vehicle 101. In another embodiment, the content providers 127 may manage access to a central repository of data, and offer a consistent, standard interface to data, such as a repository of the geographic database 105.

In one optional embodiment, the vehicles 101 and/or UEs 113 are configured with various sensors 115 for generating or collecting sensor observations (e.g., for processing by the mapping platform 107), related geographic data, etc. In one embodiment, the sensed data represents sensor data associated with a geographic location or coordinates at which the sensor data was collected to provide vehicle drive data 111. By way of example, the sensors 115 may include a global positioning sensor for gathering location data (e.g., GNSS/GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road boundaries, road sign information, images of road obstructions, etc. for analysis), LiDAR, radar, an audio recorder for gathering audio data, velocity sensors mounted on steering wheels of the vehicles, switch sensors for determining whether one or more vehicle switches are engaged, and the like.

In another optional embodiment, the communication network 117 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio Networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 107, services platform 123, services 125, vehicle 101, UE 113, and/or content providers 127 optionally communicate with each other and other components of the system 100 using well known, new or still developing protocols. In this context, a protocol includes a set of rules defining how the network nodes within the communication network 117 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

FIG. 10 is a diagram of the geographic database 105, according to one embodiment. In one embodiment, the geographic database 105 includes geographic data 1001 used for (or configured to be compiled to be used for) mapping and/or navigation-related services, such as for video odometry based on the parametric representation of signs include, e.g., encoding and/or decoding parametric representations into object models of signs. In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 105.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 105 follows certain conventions. For example, links do not cross themselves and do not cross each other except at a node. Also, there are no duplicated shape points, nodes, or links. Two links that connect each other have a common node. In the geographic database 105, overlapping geographic features are represented by overlapping polygons. When polygons overlap, the boundary of one polygon crosses the boundary of the other polygon. In the geographic database 105, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 105 includes node data records 1003, road segment or link data records 1005, POI data records 1007, stop data records 1009, other records 1011, and indexes 1013, for example. More, fewer, or different data records can be provided. In one embodiment, additional data records (not shown) can include cartographic (“carto”) data records, routing data, and maneuver data. In one embodiment, the indexes 1013 may improve the speed of data retrieval operations in the geographic database 105. In one embodiment, the indexes 1013 may be used to quickly locate data without having to search every row in the geographic database 105 every time it is accessed. For example, in one embodiment, the indexes 1013 can be a spatial index of the polygon points associated with stored feature polygons.

In exemplary embodiments, the road segment data records 1005 are links or segments representing roads, streets, or paths, as can be used in the calculated route or recorded route information for determination of one or more personalized routes. The node data records 1003 are end points (such as intersections) corresponding to the respective links or segments of the road segment data records 1005. The road link data records 1005 and the node data records 1003 represent a road network, such as used by vehicles, cars, and/or other entities. Alternatively, the geographic database 105 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 105 can include data about the POIs and their respective locations in the POI data records 1007. The geographic database 105 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 105 can also include lane transition records 1009 for storing lane transition data 109, vehicle drive data 111, aggregated drive geometry data 119, planned maneuver data 121, and/or any related data generated or used according to the various embodiments described herein. In one embodiment, the lane transition data records 1009 can be associated with one or more of the node records 1003, road segment records 1005, and/or POI data records 1007 to associate the map matching results 119 with specific geographic locations. In this way, the map matching results 119 can also be associated with the characteristics or metadata of the corresponding records 1003, 1005, and/or 1007.

In one embodiment, the geographic database 105 can be maintained by the content provider 127 in association with the mapping platform 107 and/or services platform 123 (e.g., a map developer). The map developer can collect geographic data to generate and enhance the geographic database 105. There can be different ways used by the map developer to collect data. These ways can include obtaining data from other sources, such as municipalities or respective geographic authorities. In addition, the map developer can employ field personnel to travel by vehicle (e.g., vehicle) along roads throughout the geographic region to observe features and/or record information about them, for example. Also, remote sensing, such as aerial or satellite photography, can be used.

The geographic database 105 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing behavioral driven lane transitions from crowd sourced sensor data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

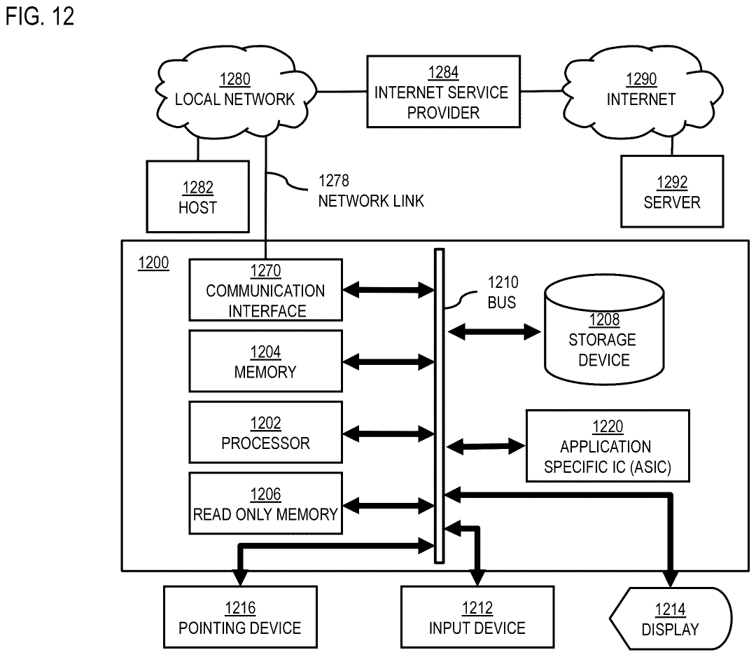

FIG. 12 illustrates a computer system 1200 upon which an embodiment of the invention may be implemented. Computer system 1200 is programmed (e.g., via computer program code or instructions) to provide behavioral driven lane transitions from crowd sourced sensor data as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1210 includes one or more parallel conductors of information so that information is transferred quickly among devices coupled to the bus 1210. One or more processors 1202 for processing information are coupled with the bus 1210.

A processor 1202 performs a set of operations on information as specified by computer program code related to providing behavioral driven lane transitions from crowd sourced sensor data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or other dynamic storage device, stores information including processor instructions for providing behavioral driven lane transitions from crowd sourced sensor data. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for providing behavioral driven lane transitions from crowd sourced sensor data, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT) or a liquid crystal display (LCD), or plasma screen or printer for presenting text or images, and a pointing device 1216, such as a mouse or a trackball or cursor direction keys, or motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the communication network 117 for providing behavioral driven lane transitions from crowd sourced sensor data.

The term computer-readable medium is used herein to refer to any medium that participates in providing information to processor 1202, including instructions for execution. Such a medium may take many forms, including, but not limited to, non-volatile media, volatile media and transmission media. Non-volatile media include, for example, optical or magnetic disks, such as storage device 1208. Volatile media include, for example, dynamic memory 1204.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290.

A computer called a server host 1292 connected to the Internet hosts a process that provides a service in response to information received over the Internet. For example, server host 1292 hosts a process that provides information representing video data for presentation at display 1214. It is contemplated that the components of system can be deployed in various configurations within other computer systems, e.g., host 1282 and server 1292.

FIG. 13 illustrates a chip set 1300 upon which an embodiment of the invention may be implemented. Chip set 1300 is programmed to provide behavioral driven lane transitions from crowd sourced sensor data as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform the inventive steps described herein to provide behavioral driven lane transitions from crowd sourced sensor data. The memory 1305 also stores the data associated with or generated by the execution of the inventive steps.

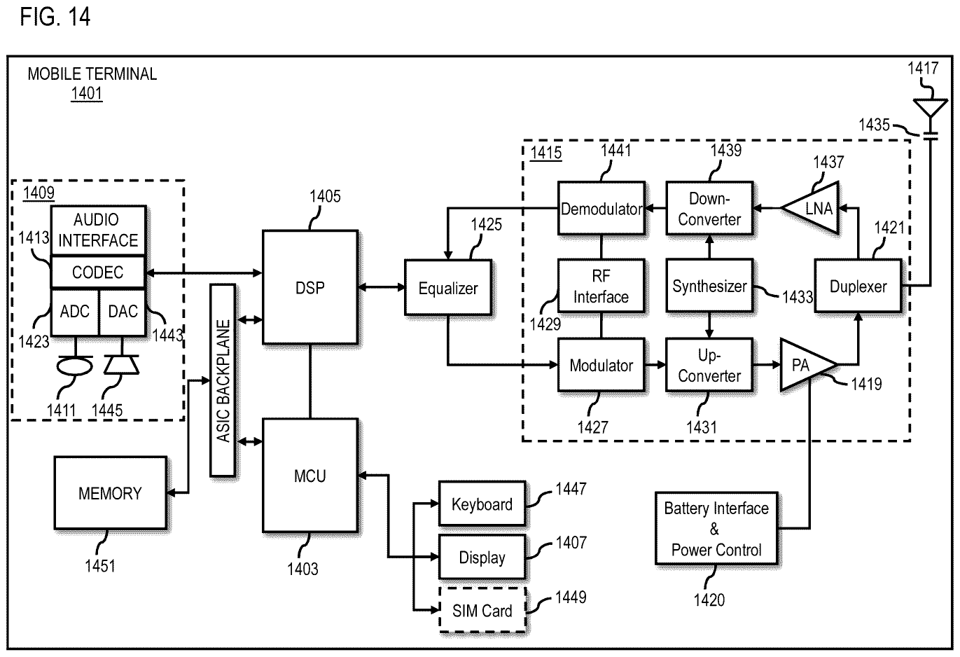

FIG. 14 is a diagram of exemplary components of a mobile terminal (e.g., handset) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile station functions that offer automatic contact matching. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile station 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403-which can be implemented as a Central Processing Unit (CPU) (not shown).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile station 1401 to provide behavioral driven lane transitions from crowd sourced sensor data. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the station. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile station 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1451 may be, but not limited to, a single memory, CD, DVD, ROM, RAM, EEPROM, optical storage, or any other non-volatile or non-transitory storage medium capable of storing digital data.

An optionally incorporated SIM card 1449 carries, for instance, important information, such as the cellular phone number, the carrier supplying service, subscription details, and security information. The SIM card 1449 serves primarily to identify the mobile station 1401 on a radio network. The card 1449 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
processing vehicle drive data to determine a plurality of aggregated vehicle drive geometries, wherein the vehicle drive data is determined using one or more sensors of one or more vehicles, and wherein the plurality of aggregated vehicle drive geometries reduce the vehicle drive data to one path per lane, one path per maneuver, or a combination thereof;
associating and clustering the plurality of aggregated vehicle drive geometries into a plurality of vehicle drive path segments;
for one or more vehicle drive path segments of the plurality of vehicle drive path segments, determining one or more counts of a number of the one or more vehicles that cross a lane marking, that depart or enter the one or more drive path segments, that have an active turn signal, or a combination thereof;
computing a lane transition type, a lane transition score, or a combination thereof for the one or more vehicle drive path segments based on the one or more counts; and
providing the lane transition type, the lane transition score, or a combination thereof as an output.

2. The method of claim 1, wherein the one or more counts include a first count or rate of a number of the one or more vehicles that crossed a lane marking to a left side, a second count or rate of a number of the one or more vehicles that crossed the lane marking to a right side, a third count or rate of a number of the one or more vehicles that entered the one or more vehicle path segments by crossing the lane marking from the left side, a fourth count or rate of a number of the one or more vehicles that entered the one or more vehicle path segments by crossing the lane marking from the right side, or a combination thereof.

3. The method of claim 1, wherein the one or more counts include a fifth count or rate of a number of the one or more vehicles that departed the one or more drive path segments to the left side, a sixth count or rate of a number of the one or more vehicles that departed the one or more drive path segments to the right side, a seventh count or rate of a number of the one or more vehicles that entered the one or more vehicle path segments from the left side, an eighth count or rate of a number of the one or more vehicles that entered the one or more vehicle path segments from the right side, or combination thereof.

4. The method of claim 1, wherein the one or more counts include a ninth count or rate of a number of the one or more vehicles with an active left turn signal, a tenth count or rate of a number of the one or more vehicles with an active right turn signal, or a combination thereof.

5. The method of claim 1, wherein the output is provided as data for planning a beginning, an end, or a combination thereof a planned lane transition.

6. The method of claim 1, wherein the output is provided as data for determining where one or more other vehicles may enter or depart a drive lane.

7. The method of claim 1, wherein the output is provided as data for indicating that multiple drive lanes are to be used for automated path planning.

8. The method of claim 1, wherein the output is provided as data for determining where one or more turn signals are to be turned on or turned off.

9. The method of claim 1, further comprising:
processing the vehicle drive data to determine one or more lane transition locations where a drive path crosses any lane markings; and
flagging one or more other drive points within a threshold proximity of the one or more lane transition locations as being nearby a lane change.

10. The method of claim 1, wherein the associating and clustering of the plurality of aggregated vehicle drive geometries into the plurality of vehicle drive path segments comprise:
dividing one or more drive paths in the aggregated vehicle drive geometries into a plurality of segments;
clustering the plurality of segments such that one or more overlapping segments of the one or more drive paths are aggregated into one or more combined segments, wherein the one or more combined segments represent a unique lane or maneuver; and
re-assembling the clustered plurality of segments into the plurality of aggregated vehicle drive geometries.

11. The method of claim 1, wherein the associating of the aggregated vehicle drive geometries is by associating a proximity, a heading, a future maneuver, a past maneuver, or a combination thereof of the one or more vehicles.

12. The method of claim 1, further comprising:
processing the output to determine a behavior model.

13. The method of claim 1, further comprising:
associating the lane transition score or data associated with the lane transition score to digital map data of a geographic database.

14. An apparatus comprising:
at least one processor; and
at least one memory including computer program code for one or more programs, the at least one memory and the computer program code configured to, with the at least one processor, cause the apparatus to:
process vehicle drive data to determine a plurality of aggregated vehicle drive geometries, wherein the vehicle drive data is determined using one or more sensors of one or more vehicles, and wherein the plurality of aggregated vehicle drive geometries reduce the vehicle drive data to one path per lane, one path per maneuver, or a combination thereof;
associate and cluster the plurality of aggregated vehicle drive geometries into a plurality of vehicle drive path segments;
for one or more vehicle drive path segments of the plurality of vehicle drive path segments, determine one or more counts of a number of the one or more vehicles that cross a lane marking, that depart or enter the one or more drive path segments, that have an active turn signal, or a combination thereof;
compute a lane transition type, a lane transition score, or a combination thereof for the one or more vehicle drive path segments based on the one or more counts; and
provide the lane transition type, the lane transition score, or a combination thereof as an output.

15. The apparatus of claim 14, wherein the one or more counts include a first count or rate of a number of the one or more vehicles that crossed a lane marking to a left side, a second count or rate of a number of the one or more vehicles that crossed the lane marking to a right side, a third count or rate of a number of the one or more vehicles that entered the one or more vehicle path segments by crossing the lane marking from the left side, a fourth count or rate of a number of the one or more vehicles that entered the one or more vehicle path segments by crossing the lane marking from the right side, or a combination thereof.

16. The apparatus of claim 14, wherein the one or more counts include a fifth count or rate of a number of the one or more vehicles that departed the one or more drive path segments to the left side, a sixth count or rate of a number of the one or more vehicles that departed the one or more drive path segments to the right side, a seventh count or rate of a number of the one or more vehicles that entered the one or more vehicle path segments from the left side, an eighth count or rate of a number of the one or more vehicles that entered the one or more vehicle path segments from the right side, or combination thereof.

17. The apparatus of claim 14, wherein the one or more counts include a ninth count or rate of a number of the one or more vehicles with an active left turn signal, a tenth count or rate of a number of the one or more vehicles with an active right turn signal, or a combination thereof.

18. A non-transitory computer-readable storage medium, carrying one or more sequences of one or more instructions which, when executed by one or more processors, cause an apparatus to perform:
processing vehicle drive data to determine a plurality of aggregated vehicle drive geometries, wherein the vehicle drive data is determined using one or more sensors of one or more vehicles, and wherein the plurality of aggregated vehicle drive geometries reduce the vehicle drive data to one path per lane, one path per maneuver, or a combination thereof;
associating and clustering the plurality of aggregated vehicle drive geometries into a plurality of vehicle drive path segments;
for one or more vehicle drive path segments of the plurality of vehicle drive path segments, determining one or more counts of a number of the one or more vehicles that cross a lane marking, that depart or enter the one or more drive path segments, that have an active turn signal, or a combination thereof;
computing a lane transition type, a lane transition score, or a combination thereof for the one or more vehicle drive path segments based on the one or more counts; and
providing the lane transition type, the lane transition score, or a combination thereof as an output.

19. The non-transitory computer-readable storage medium of claim 18, wherein the one or more counts include a first count or rate of a number of the one or more vehicles that crossed a lane marking to a left side, a second count or rate of a number of the one or more vehicles that crossed the lane marking to a right side, a third count or rate of a number of the one or more vehicles that entered the one or more vehicle path segments by crossing the lane marking from the left side, a fourth count or rate of a number of the one or more vehicles that entered the one or more vehicle path segments by crossing the lane marking from the right side, or a combination thereof.

20. The non-transitory computer-readable storage medium of claim 18, wherein the one or more counts include a fifth count or rate of a number of the one or more vehicles that departed the one or more drive path segments to the left side, a sixth count or rate of a number of the one or more vehicles that departed the one or more drive path segments to the right side, a seventh count or rate of a number of the one or more vehicles that entered the one or more vehicle path segments from the left side, an eighth count or rate of a number of the one or more vehicles that entered the one or more vehicle path segments from the right side, or combination thereof.
